(19) United States
(12) Patent Application Publication
(10) Pub. No.: US 2015/0143215 A1
(43) Pub. Date: May 21, 2015

(54) METHOD AND SYSTEM FOR ACCESSING AUDIO/VIDEO COMMUNITY VIRTUAL ROOMS

(71) Applicant: TENCENT TECHNOLOGY (SHENZHEN) COMPANY LIMITED, Shenzhen (CN)

(72) Inventors: KE HU, Shenzhen (CN); CHUNLIN ZHU, Shenzhen (CN); LIANGFU SUN, Shenzhen (CN); NING CAO, Shenzhen (CN)

(73) Assignee: TENCENT TECHNOLOGY (SHENZHEN) COMPANY LIMITED

(21) Appl. No.: 14/604,857

(22) Filed: Jan. 26, 2015

Related U.S. Application Data
(63) Continuation of application No. PCT/CN2013/085163, filed on Oct. 14, 2013.

(30) Foreign Application Priority Data
Oct. 15, 2012 (CN) 2012-10390323.7

(51) Int. Cl. G06F 17/22; H04L 29/06

(52) U.S. Cl. CPC G06F 17/2235; H04L 67/42
USPC 715/205

(57) ABSTRACT

A method is provided for accessing an audio/video community virtual room. The method includes receiving a trigger request on a link address corresponding to a visual room identifier displayed on a group webpage. A corresponding relationship exists between the visual room identifier and a group identifier. The method also includes starting an audio/video community application program to enter a virtual room interactive interface of the link address corresponding to the visual room identifier according to the trigger request.

### CROSS-REFERENCES TO RELATED APPLICATIONS

This application is a continuation application of PCT Patent Application No. PCT/CN2013/085163, filed on Oct. 14, 2013, which claims the priority of Chinese patent application no. 201210390323.7, filed on Oct. 15, 2012, the entire contents of all of which are incorporated herein by reference.

### FIELD OF THE INVENTION

The present invention generally relates to the field of computer network technology and, more particularly, to methods and systems for accessing virtual rooms in an audio/video community.

### BACKGROUND

With the development of computer network technologies, more and more people are used to communicate with each other on the network. Such communication can be performed via a variety of ways. People can use instant messaging tools for one to one communication, use instant messaging tools to build a group and communicate with each other within the group, or communicate with one another in audio/video communities, such as an instant messaging (IM) community.

There are a variety of virtual rooms created by users in an audio/video community, as well as official virtual rooms created by the audio/video community. Traditional methods used for accessing the virtual rooms in the audio/video community may involve in installing the ActiveX plug-in or other program on a separate webpage, which requires accessing the separate webpage in the instant messaging tool in order to enter a virtual room and then manually closing the webpage. That is, the traditional methods require users to access an extra webpage in order to enter the virtual room and then close the webpage after entering the virtual room, which causes inconvenient operations.

The disclosed method and system are directed to solve one or more problems set forth above and other problems.

### BRIEF SUMMARY OF THE DISCLOSURE

One aspect of the present disclosure includes an audio/video community virtual room accessing method. The method includes receiving a trigger request on a link address corresponding to a visual room identifier displayed on a group webpage. A corresponding relationship exists between the visual room identifier and a group identifier. The method also includes starting an audio/video community application program to enter a virtual room interactive interface of the link address corresponding to the visual room identifier according to the trigger request.

Another aspect of the present disclosure includes an audio/video community virtual room accessing system. The system includes a trigger module and an execution module. The trigger module is configured to receive a trigger request on a link address corresponding to a visual room identifier displayed on a group webpage, and a corresponding relationship exists between the visual room identifier and a group identifier. The execution module is configured to start an audio/video community application program to enter a virtual room interactive interface of the link address corresponding to the visual room identifier according to the trigger request.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary audio/video community virtual room accessing process consistent with the disclosed embodiments;

FIG. 2 illustrates an exemplary process for establishing a corresponding relationship between a group identifier and a virtual room identifier consistent with the disclosed embodiments;

FIG. 3 illustrates an exemplary virtual room configuration interface consistent with the disclosed embodiments;

FIG. 4 illustrates another exemplary process for establishing a corresponding relationship between a group identifier and a virtual room identifier consistent with the disclosed embodiments;

FIG. 5 illustrates an exemplary association configuration webpage interface consistent with the disclosed embodiments;

FIG. 6 illustrates an exemplary audio/video community virtual room accessing system consistent with the disclosed embodiments;

FIG. 7 illustrates another exemplary audio/video community virtual room accessing system consistent with the disclosed embodiments;

FIG. 8 illustrates an exemplary associating module consistent with the disclosed embodiments;

FIG. 9 is illustrates another exemplary associating module consistent with the disclosed embodiments;

FIG. 10 illustrates an exemplary operating environment incorporating certain disclosed embodiments; and

FIG. 11 illustrates a block diagram of an exemplary computer system consistent with the disclosed embodiments.

### DETAILED DESCRIPTION

Reference will now be made in detail to exemplary embodiments of the invention, examples of which are illustrated in the accompanying drawings. Wherever possible, the same reference numbers will be used throughout the drawings to refer to the same or like parts.

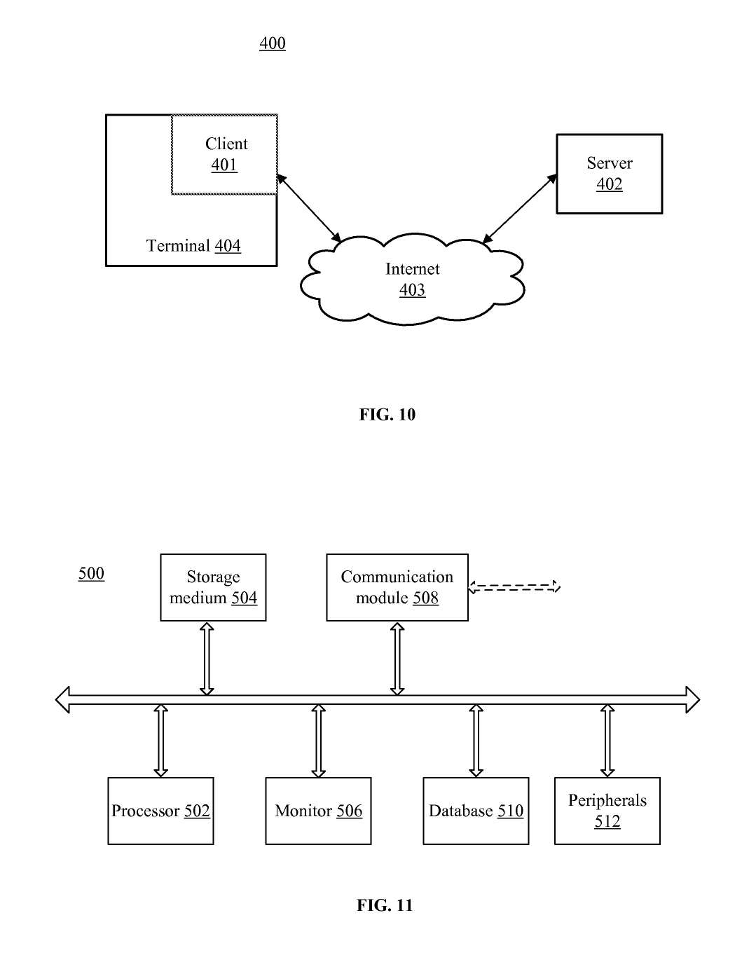

FIG. 10 illustrates an exemplary operating environment 400 incorporating certain disclosed embodiments. As shown in FIG. 10, environment 400 may include a terminal 404, the Internet 403, and servers 402. The Internet 403 may include any appropriate type of communication network for providing network connections to the terminal 404 and the server 402. For example, Internet 403 may include the Internet or other types of computer networks or telecommunication networks, either wired or wireless.

A server, as used herein, may refer to one or more server computers configured to provide certain web server functionalities to provide certain personalized services, which may require any user accessing the services to authenticate to the server before the access. A web server may also include one or more processors to execute computer programs in parallel.

The servers 402 may include any appropriate server computers configured to provide certain server functionalities, such as a web server functionality, a group server functionality (e.g., an IM server or QQ server), and/or an audio/video community server functionality for responding a user's request for community/group operations including virtual room functionalities and interactions. Although only one server is shown, any number of servers can be included. The server 402 may be operated in a cloud or non-cloud computing environment.

Terminal 404 may include any appropriate type of mobile computing devices, such as mobile phones, smart phones, tablets, notebook computers, or any type of computing platform. Terminal 404 may include one or more clients 401. The client 401, as used herein, may include any appropriate mobile application software, hardware, or a combination of application software and hardware to achieve certain client functionalities. For example, client 401 may include a mobile browser. According to actual needs in different terminals, a mobile client may be a browser installed on the terminal for browsing, including various types of existing and future browser installed on terminals. Although only one client 401 is shown in the environment 400, any number of clients 401 may be included.

Terminal 404 and/or server 402 may be implemented on any appropriate computing platform. FIG. 11 illustrates a block diagram of an exemplary computer system 500 capable of implementing terminal 404 and/or server 402.

As shown in FIG. 11, computer system 500 may include a processor 502, a storage medium 504, a monitor 506, a communication module 508, a database 510, and peripherals 512. Certain devices may be omitted and other devices may be included.

Processor 502 may include any appropriate processor or processors. Further, processor 502 can include multiple cores for multi-thread or parallel processing. Storage medium 504 may include memory modules, such as Read-only memory (ROM), Random Access Memory (RAM), flash memory modules, and erasable and rewritable memory, and mass storages, such as CD-ROM, U-disk, and hard disk, etc. Storage medium 504 may store computer programs for implementing various processes, when executed by processor 502.

Further, peripherals 512 may include I/O devices such as keyboard and mouse, and communication module 508 may include network devices for establishing connections through the communication network. Database 510 may include one or more databases for storing certain data and for performing certain operations on the stored data, such as database searching.

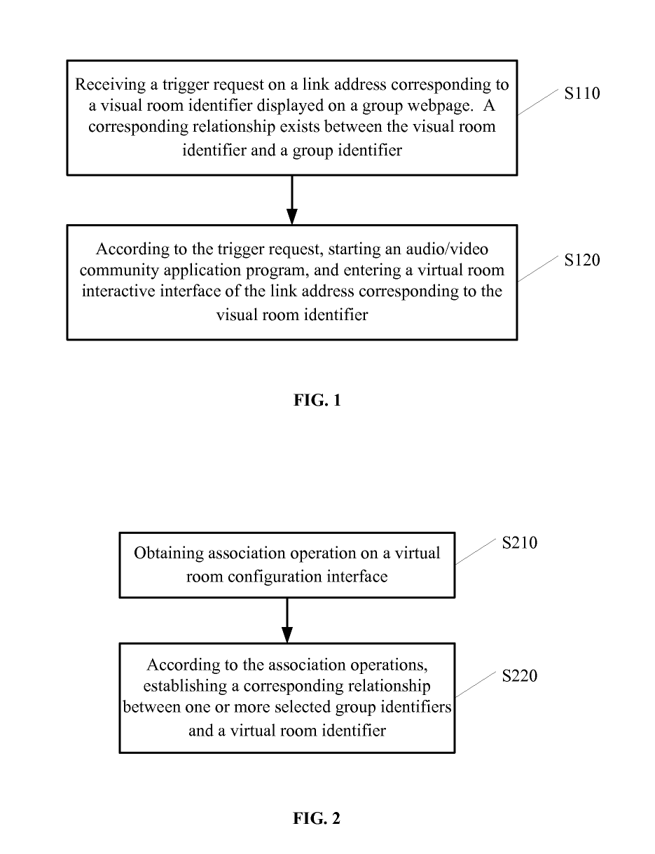

In operation, terminals/clients and/or servers 402 may provide a mobile browser bookmark moving service to a user of the terminal. FIG. 1 illustrates a flow diagram of an exemplary bookmark moving process consistent with the disclosed embodiments.

In operation, client 401 may cause terminal 404 and server 402 to perform certain actions, such as an audio/video community operation or a group operation, or a virtual room related operation. Terminal 404 and server 402 may be configured to provide structures and functions for such actions and operations. FIG. 1 illustrates an exemplary audio/video community virtual-room accessing process consistent with the disclosed embodiments.

As shown in FIG. 1, the virtual room accessing process may include the following steps.

Step S110: receiving a trigger request on a link address corresponding to a visual room identifier displayed on a group webpage. A corresponding relationship exists between the visual room identifier and a group identifier.

More specifically, a group may refer to a collection of identifiers of group members with same or similar attribute data. The attribute data may include age, hometown, school, interests, work classification, location and so on. The groups may be a relationship network among the member identifiers of instant messaging (IM) groups, class groups in alumni networks, and microblogs (Weibo). A group webpage may refer to an embedded webpage on a group client, e.g., a group members' client.

The group webpage may display a link address corresponding to a virtual room identifier or multiple link addresses corresponding to multiple virtual room identifiers, with each link address corresponding to one virtual room identifier. Further, each virtual room identifier corresponds to and is associated with a group identifier. That is, one group identifier can be associated with one or more virtual rooms. Similarly, a virtual room identifier can be associated with one or more group identifiers. The group identifiers are used to distinguish individual groups, with each group having a unique identifier, and the visual room identifiers are used to distinguish virtual rooms, with each virtual room having a unique virtual room identifier. For example, a group identifier can be Q001 and a virtual room identifier can be R0001, etc., any type or format of identifier may be used, such as character, number, and/or other symbols.

Further, the link addresses of multiple virtual room identifiers are displayed on a group webpage can help the group members to conveniently select virtual rooms of interest.

Step S120: according to the trigger request, an audio/video community application program is started, entering a virtual room interactive interface of the link address corresponding to the visual room identifier.

Specifically, according to the trigger request, the system can call a predefined protocol to start an initial startup program registered by a registry table and the initial startup program can then start the audio/video community application program to enter the virtual room interactive interface. The initial startup program can be a predefined startup program, such as a predefined protocol processing program. The virtual room interactive interface is an interface for exchanging audio/video information and text messages, and it can be used to search the virtual room member information, to receive audio information, and to display video information, etc. The virtual room interactive interface can also be used to sort the order of the visual room member identifiers and to receive the corresponding audio information sent from the member identifiers according to the sorted order.

This method for accessing the audio/video community virtual room can allow group members to directly enter the audio/video community virtual room by triggering the address link of the virtual room on the group webpage without jumping onto or switching to a new webpage. It is easy to access the visual room via the group webpage without opening an extra webpage. The amount of operations of downloading the new webpage contents and rendering the new webpage can be reduced, further saving network resources and processing resources.

In one embodiment, before obtaining the trigger request of the link address corresponding to a visual room identifier displayed on the group webpage, the virtual room accessing process further includes obtaining an association request and establishing a corresponding relationship between the group identifier and the virtual room identifier according to the association request.

Specifically, the association request can be initiated by any group member from a client webpage on the terminal of the group member. Or the permission levels for group members (i.e., group member identifiers) can first be defined and, after receiving the association request initiated by a particular group member or group member identifier, the permission level of the group member identifier is obtained. Further, it can be determined whether the permission level of the group member identifier is greater than or equal to a predetermined permission level threshold. If the permission level of the group member is greater than or equal to the predetermined permission level threshold, the corresponding relationship between the group identifier and the virtual room identifier can be established according to the association request. Otherwise, the accessing process is ended. The predetermined permission level threshold can be the permission level of the group administrator or the group creator. The client webpage can be an embedded webpage on an IM client, an association configuration webpage, or a virtual room configuration interface, etc.

In addition, after establishing the corresponding relationship between the group identifier and the virtual room identifier, the group webpage can be used to publish an announcement made by group members. The permission level for publishing such announcement may be set as well, so that only the group creator or the group administrator can publish such announcement.

Further, in one embodiment, after obtaining the association request and establishing the corresponding relationship between group identifier and the virtual room identifier according to the association request, the virtual room accessing process may further include obtaining a association cancel request and cancelling the corresponding relationship between the group identifier and the virtual room identifier according to the association cancel request.

Specifically, the association cancel request can be initiated by any group member from a client webpage on the terminal of the group member. Or the permission levels for group members (i.e., group member identifiers) can first be defined and, after receiving the association cancel request initiated by the particular group member or group member identifier, the permission level of the group member identifier is obtained. Further, it can be determined whether the permission level of the group member identifier is greater than or equal to a predetermined permission level threshold. If the permission level of the group member is greater than or equal to the predetermined permission level threshold, the corresponding relationship between the group identifier and the virtual room identifier can be deleted according to the association cancel request. The predetermined permission level threshold can be the permission level of the group administrator or the group creator. The client webpage can be an embedded webpage on an IM client, an association configuration webpage, or a virtual room configuration interface, etc

Further, in one embodiment, as shown in FIG. 2, the process of obtaining the association request and establishing the corresponding relationship between the group identifier and the virtual room identifier according to the association request may further include the following steps.

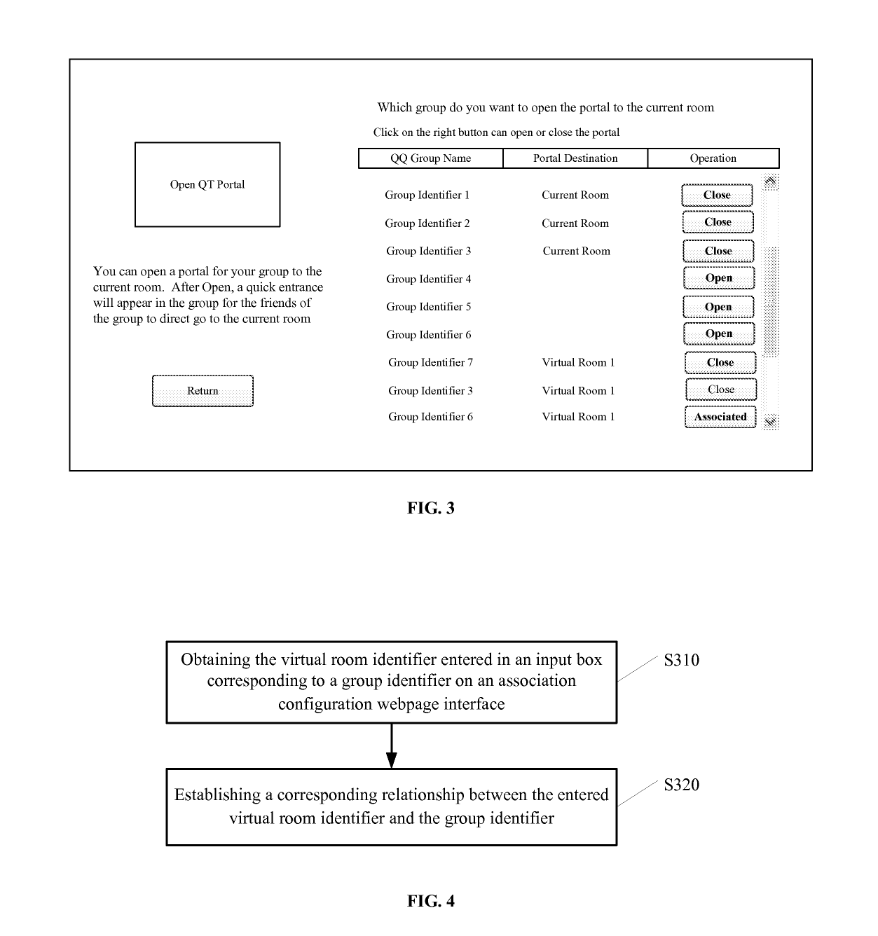

Step S210: obtaining association operation on a virtual room configuration interface. Specifically, the virtual room configuration interface may refer to an interface for performing configuration operations on a virtual room. As shown in FIG. 3, the information displayed on the virtual room configuration interface contains names of instant messaging groups, the destination of the portal (i.e. the virtual room) and operations. The operations may include “Open” and “Close”, wherein “Open” operation refers to associating the selected instant messaging group with the virtual room, and “Close” operation refers to cancelling the corresponding relationship between the associated instant messaging group identifier and the virtual room identifier.

Before Step S210 is performed, the process further includes: logging in the audio/video community, accessing the virtual room configuration interface; obtaining group identifiers and displaying the group identifiers on the virtual room configuration interface. Specifically, an audio/video community application program may be started to log in the audio/video community via a shared community group member identify in the audio/video community.

Further, a selected virtual room configuration interface is accessed. Any virtual room may be used, based on user requirements. The group identifiers associated with the group member identifiers are pulled from the group server from a predefined group interface and displayed on the virtual room configuration interface. These group identifiers can then be used for the association operation (“Open”) or association cancel operations (“Close”). A corresponding relationship existed between a group member identifier and a group identifier. For example, if a group is an instant messaging group, the group member identifiers are accounts of their instant messaging group members; or if a group is a microblog, the group member identifiers are microblog accounts of the group members.

Step S220, according to the association operations, a corresponding relationship can be established between one or more selected group identifiers and a virtual room identifier.

Specifically, one or more group identifiers can be selected as needed, and the group identifiers can be respectively associated with the virtual room identifier. As shown in FIG. 3, the displayed plurality of group identifiers can be respectively associated with a virtual room identifier. Thus, members from different groups can get together in a same virtual room.

Further, in one embodiment, as shown in FIG. 4, the process for obtaining the association request and establishing a corresponding relationship between a group identifier and a virtual room identifier according to the association request may further include the following steps.

Step S310: obtaining the virtual room identifier entered in an input box corresponding to a group identifier on an association configuration webpage interface. Specifically, multiple group identifiers are displayed on the association configuration webpage interface, and an input box is provided at each group identifier for entering a visual room identifier. The virtual room identifier can be entered using a physical or virtual keyboard. Alternatively, a drop-down list can be provided in the input box, and the virtual room identifier can be selected from a list of virtual room identifiers on the drop-down list for the user to select a virtual room identifier as the inputted virtual room identifier.

As shown in FIG. 5, the association configuration webpage interface shows a plurality of group identifiers, which are the group names in this embodiment. An input box is provided for each group name and arranged following the group name at the same row. The virtual room identifier can be entered in the corresponding input box. Different virtual room identifiers or the same virtual room identifier may be entered in the input boxes of different group identifiers.

The association configuration webpage interface can be used to establish the corresponding relationship between the group identifier and a virtual room identifier, and can also be used to cancel the existing corresponding relationship between the group identifier and a virtual room identifier. As shown in FIG. 5, after a virtual room identifier is entered into the input box and “OK” button is clicked, a request is sent to the audio/video community server for associating the group identifier with the virtual room identifier.

The audio/video community server may verify whether the virtual room identifier exists. If the virtual room identifier exists, the group identifier can be associated with the virtual room identifier. If the virtual room identifier does not exist, a message that the virtual room identifier does not exist can be returned and shown on the association configuration webpage interface.

Step S320: establishing a corresponding relationship between the entered virtual room identifier and the group identifier. Specifically, the audio/video community server can verify whether the entered virtual room identifier exists. If the entered virtual room identifier exists, a corresponding relationship between the entered virtual room identifier and the group identifier can be established. Otherwise, a message that the virtual room does not exist can be returned and displayed on the association configuration webpage interface.

Further, in one embodiment, the process for obtaining the association request and establishing the corresponding relationship between the group identifier and the virtual room identifier according to the association request may further include: obtaining the virtual room identifier entered in the input box on the group webpage; and establishing a corresponding relationship between the group identifier and the virtual room identifier.

Specifically, the group webpage may refer to the embedded webpage of the group on the client. The virtual room identifier can be entered using a physical or virtual keyboard. Alternatively, a drop-down list can be provided in the input box, and the virtual room identifier can be selected from a list of virtual room identifiers on the drop-down list for the user to select a virtual room identifier as the inputted virtual room identifier. The group webpage can be used to establish the corresponding relationship between the group identifier and virtual room identifier or to cancel the established relationship between the group identifier and virtual room identifier.

Further, in one embodiment, after obtaining the association request and establishing the corresponding relationship between the group identifier and the virtual room identifier according to the association request, the process further includes: marking a status flag of the corresponding relationship between the group identifier and the virtual room identifier, and recording the status flag.

Specifically, after establishing the corresponding relationship between the group identifier and the virtual room identifier, the audio/video community server may mark the status flag of the corresponding relationship between the group identifier and the virtual room identifier, and may synchronize the status flag with the group server. The group sever can then record the status flag such that the status flag can be downloaded by a group client conveniently and can be displayed on the group client to notify group members that the group identifiers have been associated with the virtual room identifier. The group client may be an IM client or client of other groups.

Further, in one embodiment, before starting the audio/video community application program according to the trigger request, the process further includes: determining whether the audio/video community application program is installed. If the audio/video community application program is installed, starting the audio/video community application program according to the trigger request. Otherwise, the installation file of the audio/video community application program is downloaded and executed to install the audio/video community application program, and then starting the installed audio/video community application program.

Specifically, the installation file of the audio/video community application program can be automatically downloaded from a provided website. In addition, before downloading the installation file, a message may be prompted as whether to download the installation file should be downloaded. After obtaining a touch operation or other command operation, if it is a confirmation operation, i.e., downloading the installation file, the installation file is downloaded. If it is not a confirmation operation, stopping download of the installation file.

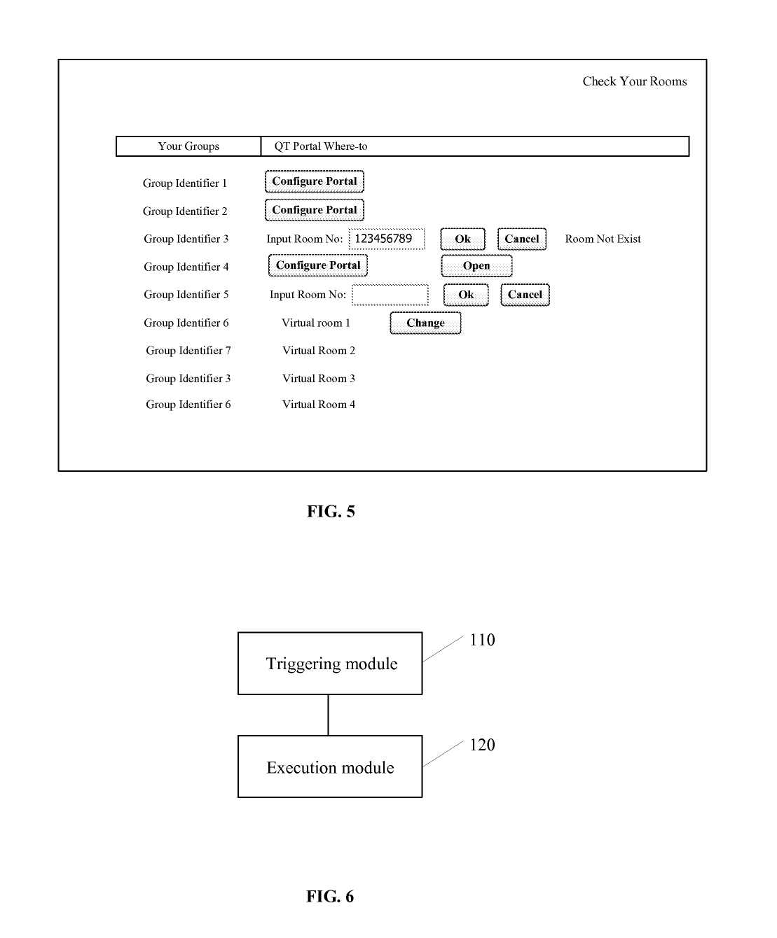

FIG. 6 illustrates an exemplary audio/video community virtual-room accessing system consistent with the disclosed embodiments. As shown in FIG. 6, the audio/video community virtual-room accessing system includes a trigger module 110 and an execution module 120. Other modules may also be included. In certain embodiments, both trigger module 110 and execution module 120 are located on a group client.

The trigger module 110 is provided for receiving a trigger request on a link address corresponding to a visual room identifier displayed on a group webpage. A corresponding relationship exists between the visual room identifier and a group identifier.

Specifically, a group may refer to a collection of identifiers of group members with same or similar attribute data. The attribute data may include age, hometown, school, interests, work classification, location and so on. The groups may be a relationship network among the member identifiers of instant messaging (IM) groups, class groups in alumni networks, and microblogs. A group webpage may refer to an embedded webpage on a group client, e.g., a group members' client.

The group webpage may display a link address corresponding to a virtual room identifier or multiple link addresses corresponding to multiple virtual room identifiers, with each link address corresponding to one virtual room identifier. Further, each virtual room identifier corresponds to and is associated with a group identifier. That is, one group identifier can be associated with one or more virtual rooms. Similarly, a virtual room identifier can be associated with one or more group identifiers. The group identifiers are used to distinguish individual groups, with each group having a unique identifier, and the visual room identifiers are used to distinguish virtual rooms, with each virtual room having a unique virtual room identifier. For example, a group identifier can be Q001 and a virtual room identifier can be R0001, etc., any type or format of identifier may be used, such as character, number, and/or other symbols.

Further, the link addresses of multiple virtual room identifiers are displayed on a group webpage can help the group members to conveniently select virtual rooms of interest.

The execution module 120 is provided for starting an audio/video community application program according to the trigger request, and entering a virtual room interactive interface of the link address corresponding to the visual room identifier.

Specifically, the execution module 120 may call a predefined protocol to start an initial startup program registered by a registry table, according to the trigger request, and the initial startup program can then start the audio/video community application program to enter the virtual room interactive interface. The initial startup program can be a predefined startup program, such as a predefined protocol processing program. The virtual room interactive interface is an interface for exchanging audio/video information and text messages, and it can be used to search the virtual room member information, to receive audio information, and to display video information, etc. The virtual room interactive interface can also be used to sort the order of the visual room member identifiers and to receive the corresponding audio information sent from the member identifiers according to the sorted order.

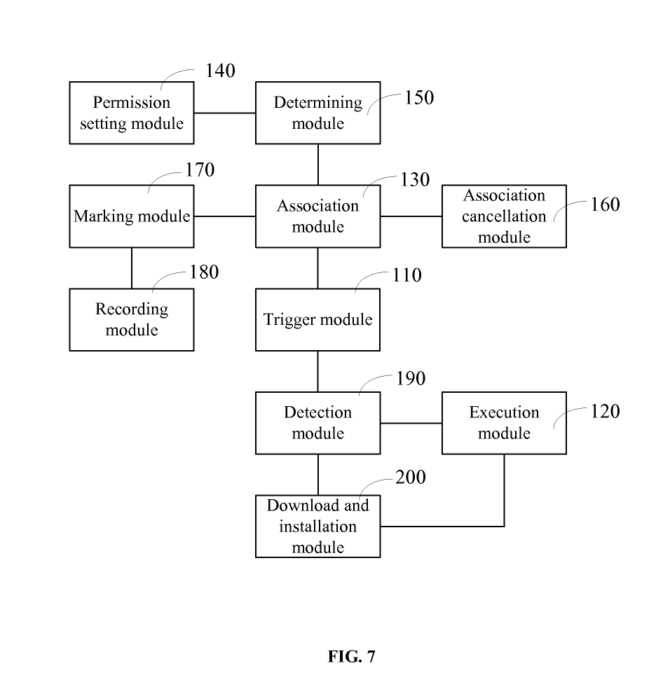

FIG. 7 illustrates another audio/video community virtual room accessing system. As shown in FIG. 7, the audio/video community virtual room accessing system may include, in addition to the trigger module 110 and execution module 120, an association module 130, a permission setting module 140, a determining module 150, an association cancellation module 160, a marking module 170, a recording module 180, a detection module 190, and a download and installation module 200.

The association module 130 may be configured on an audio/video community server and is provided for obtaining an association request and establishing a corresponding relationship between the group identifier and the virtual room identifier according to the association request.

Specifically, the association request can be initiated by any group member from a client webpage on the terminal of the group member or by any group member with an appropriate permission level. The client webpage can be an embedded webpage on an IM client, an association configuration webpage, or a virtual room configuration interface, etc.

The permission setting module 140 may be configured on the audio/video community server and is provided for define in advance permission levels of group member identifiers.

The determining module 150 may be configured on the audio/video community server and is provided for, after the association module 130 receives the association request initiated by a particular group member or group member identifier, determining the permission level of the group member identifier. If the determining module 150 determines that the permission level of the group member is greater than or equal to a predetermined permission level threshold, the association module 130 may establish the corresponding relationship between the group identifier and the virtual room identifier according to the association request. The predetermined authority level threshold can be the permission level of the group administrator or the group creator.

The association cancellation module 160 may be configured on the audio/video community server and is provided for obtaining an association cancel request and cancelling the corresponding relationship between the group identifier and the virtual room identifier according to the association cancel request.

Specifically, the association cancel request can be initiated by any group member from a client webpage on the terminal of the group member. Or the authority levels for group members (i.e., group member identifiers) can first be defined and, after receiving the association cancel request initiated by the particular group member or group member identifier, the authority level of the group member identifier is obtained. Further, it can be determined whether the authority level of the group member identifier is greater than or equal to a predetermined authority level threshold. If the authority level of the group member is greater than or equal to the predetermined authority level threshold, the corresponding relationship between the group identifier and the virtual room identifier can be deleted according to the association cancel request. The predetermined authority level threshold can be the authority level of the group administrator or the group creator. The client webpage can be an embedded webpage on an IM client, an association configuration webpage, or a virtual room configuration interface, etc.

The marking module 170 may be configured on the audio/video community server and is provided for marking a status flag of the corresponding relationship between the group identifier and the virtual room identifier.

Specifically, after the association module 130 establishes the corresponding relationship between the group identifier and the virtual room identifier, the marking module 170 may mark the status flag of the corresponding relationship between the group identifier and the virtual room identifier, and may synchronize the status flag with the group server. The group sever can then record the status flag such that the status flag can be downloaded by a group client conveniently and can be displayed on the group client to notify group members that the group identifiers have been associated with the virtual room identifier. The group client may be an IM client or client of other groups.

The recording module 180 may be configured on the group server and is provided for recording the status flag of the corresponding relationship between the group identifier and the virtual room identifier.

The detection module 190 may be provided for determining whether the audio/video community application program is installed. The download and install module 200 is provided for, when the audio/video community application program is not installed, downloading an installation file of the audio/video community application program and executing the installation file.

Specifically, the installation file of the audio/video community application program can be automatically downloaded from a provided website. In addition, before downloading the installation file, a message may be prompted as whether to download the installation file should be downloaded. After obtaining a touch operation or other command operation, if it is a confirmation operation, i.e., downloading the installation file, the installation file is downloaded. If it is not a confirmation operation, stopping download of the installation file.

Further, the execution module 120 may be configured to, when the audio/video community application program is installed, start the audio/video community application program according to the trigger request and, when the audio/video community application program is not installed, to starting the installed audio/video community application program.

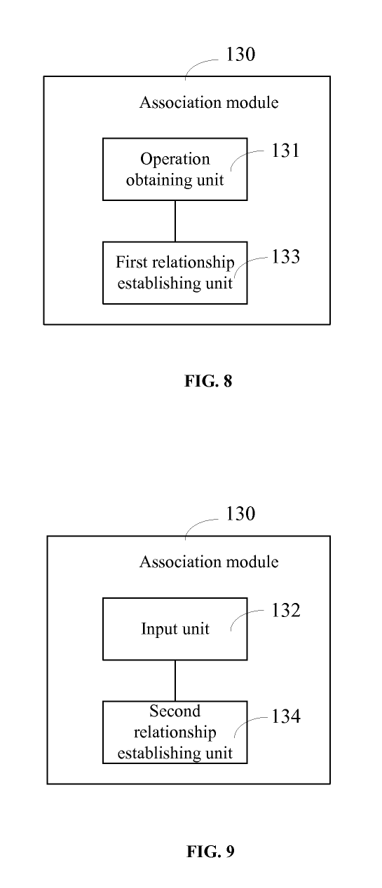

FIG. 8 illustrates an association module 130 consistent with the disclosed embodiments. As shown in FIG. 8, the association module 130 may include an operation obtaining unit 131, and a first relationship establishing unit 133.

The operation obtaining unit 131 is provided for obtaining association operation on a virtual room configuration interface. The virtual room configuration interface may refer to an interface for performing configuration operations on a virtual room. As shown in FIG. 3, the information displayed on the virtual room configuration interface contains names of instant messaging groups, the destination of the portal (i.e. the virtual room) and operations. The operations may include “Open” and “Close”, wherein “Open” operation refers to associating the selected instant messaging group with the virtual room, and “Close” operation refers to cancelling the corresponding relationship between the associated instant messaging group identifier and the virtual room identifier.

The first relationship establishing unit 133 is provided for establishing a corresponding relationship between one or more selected group identifiers and a virtual room identifier according to the association operation.

Specifically, one or more group identifiers can be selected as needed, and the group identifiers can be respectively associated with the virtual room identifier. As shown in FIG. 3, the displayed plurality of group identifiers can be respectively associated with a virtual room identifier.

In one embodiment, the audio/video community virtual room accessing system may also include a login module and a display module. The login module may be configured on a client of the audio/video community and is provided for logging in the audio/video community and accessing the virtual room configuration interface.

The display module may be configured on a client of the audio/video community and is provided for obtaining group identifiers and displaying the group identifiers on the virtual room configuration interface.

Specifically, an audio/video community application program may be started to log in the audio/video community via a shared community group member identify in the audio/video community and enters into a selected virtual room configuration interface. Any virtual room may be used, based on user requirements. The group identifiers associated with the group member identifiers are pulled from the group server from a predefined group interface and displayed on the virtual room configuration interface. These group identifiers can then be used for the association operation (“Open”) or association cancel operations (“Close”). A corresponding relationship existed between a group member identifier and a group identifier. For example, if a group is an instant messaging group, the group member identifiers are accounts of their instant messaging group members; or if a group is a microblog, the group member identifiers are microblog accounts of the group members.

FIG. 9 illustrates another association module 130 consistent with the disclosed embodiments. As shown in FIG. 9, in one embodiment, the association module 130 may include an input unit 132 and a second relationship establishing unit 134.

The input unit 132 is provided for obtaining the virtual room identifier entered in an input box corresponding to a group identifier on an association configuration webpage interface.

Specifically, multiple group identifiers are displayed on the association configuration webpage interface, and an input box is provided at each group identifier for entering a visual room identifier. The virtual room identifier can be entered using a physical or virtual keyboard. Alternatively, a drop-down list can be provided in the input box, and the virtual room identifier can be selected from a list of virtual room identifiers on the drop-down list for the user to select a virtual room identifier as the inputted virtual room identifier.

As shown in FIG. 5, the association configuration webpage interface shows a plurality of group identifiers, which are the group names in this embodiment. An input box is provided for each group name and arranged following the group name at the same row. The virtual room identifier can be entered in the corresponding input box and obtained by the input module 132. Different virtual room identifiers or the same virtual room identifier may be entered in the input boxes of different group identifiers.

The association module 130 may use the association configuration webpage interface to establish the corresponding relationship between the group identifier and a virtual room identifier. The association cancellation module 160 may use the association configuration webpage interface to cancel the existing corresponding relationship between the group identifier and a virtual room identifier. As shown in FIG. 5, after a virtual room identifier is entered into the input box and “OK” button is clicked, a request is sent to the audio/video community server for associating the group identifier with the virtual room identifier.

The audio/video community server may verify whether the virtual room identifier exists. If the virtual room identifier exists, the group identifier can be associated with the virtual room identifier. If the virtual room identifier does not exist, a message that the virtual room identifier does not exist can be returned and shown on the association configuration webpage interface.

The second relationship establishing unit 134 is provided for establishing a corresponding relationship between the entered virtual room identifier and the group identifier. Specifically, the audio/video community server can verify whether the entered virtual room identifier exists. If the entered virtual room identifier exists, the second relationship establishing unit 134 establishes a corresponding relationship between the entered virtual room identifier and the group identifier. Otherwise, the second relationship establishing unit 134 returns a message that the virtual room does not exist, and the display module displays the message on the association configuration webpage interface.

Further, in one embodiment, the input unit 134 is also provided for obtaining the virtual room identifier entered in the input box on the group webpage. The second relationship establishing unit 134 is provided for establishing a corresponding relationship between the group identifier and the virtual room identifier.

Specifically, the group webpage may refer to the embedded webpage of the group on the client. The virtual room identifier can be entered using a physical or virtual keyboard. Alternatively, a drop-down list can be provided in the input box, and the virtual room identifier can be selected from a list of virtual room identifiers on the drop-down list for the user to select a virtual room identifier as the inputted virtual room identifier. The group webpage can be used to establish the corresponding relationship between the group identifier and virtual room identifier or to cancel the established relationship between the group identifier and virtual room identifier.

Those skilled in the art should understand that all or part of the steps in the above method may be executed by relevant hardware instructed by a program, and the program may be stored in a computer-readable storage medium such as a read only memory, a magnetic disk, a Compact Disc (CD), and so on.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art.

By using the disclosed methods and structures, various online community and group application can be implemented. Various disclosed methods and systems for accessing the audio/video community virtual room can allow group members to directly enter the audio/video community virtual room by triggering the address link of the virtual room on the group webpage without jumping onto or switching to a new webpage. It is easy to access the visual room via the group webpage without opening an extra webpage. The amount of operations of downloading the new webpage contents and rendering the new webpage can be reduced, further saving network resources and processing resources.

What is claimed is:

1. An audio/video community virtual room accessing method, comprising:
receiving a trigger request on a link address corresponding to a visual room identifier displayed on a group webpage, wherein a corresponding relationship exists between the visual room identifier and a group identifier; and
according to the trigger request, starting an audio/video community application program to enter a virtual room interactive interface of the link address corresponding to the visual room identifier.

2. The audio/video community virtual room accessing method according to claim 1, before receiving the trigger request, the method further including:
obtaining an association request; and
establishing a corresponding relationship between the group identifier and the virtual room identifier according to the association request.

3. The audio/video community virtual room accessing method according to claim 2, wherein obtaining an association request and establishing a corresponding relationship further includes:
obtaining association operation on a virtual room configuration interface; and
according to the association operation, establishing a corresponding relationship between one or more selected group identifiers and a virtual room identifier.

4. The audio/video community virtual room accessing method according to claim 3, before obtaining the association operation, further including:
logging in the audio/video community;
accessing the virtual room configuration interface;
obtaining group identifiers; and
displaying the group identifiers on the virtual room configuration interface.

5. The audio/video community virtual room accessing method according to claim 2, wherein obtaining an association request and establishing the corresponding relationship further includes:
obtaining the virtual room identifier entered in an input box corresponding to a group identifier on an association configuration webpage interface; and
establishing a corresponding relationship between the entered virtual room identifier and the group identifier.

6. The audio/video community virtual room accessing method according to claim 2, further including:
obtaining a association cancel request; and
cancelling the corresponding relationship between the group identifier and the virtual room identifier according to the association cancel request.

7. The audio/video community virtual room accessing method according to claim 2, further including:
marking a status flag of the corresponding relationship between the group identifier and the virtual room identifier; and
recording the status flag.

8. The audio/video community virtual room accessing method according to claim 2, further including:
predefining permission levels of group member identifiers,
wherein establishing the corresponding relationship further includes:
obtaining the association request initiated by a group member identifier;
determining whether a permission level of the group member identifier is greater than or equal to a predetermined permission threshold; and
when the permission level of the group member identifier is greater than or equal to the predetermined permission threshold, establishing the corresponding relationship between the group identifier and the virtual room identifier according to the association request.

9. The audio/video community virtual room accessing method according to claim 1, further including:
determining whether the audio/video community application program is installed;
when the audio/video community application program is installed, starting the audio/video community application program according to the trigger request; and
when the audio/video community application program is not installed, downloading an installation file of the audio/video community application program, executing the installation file to install the audio/video community application program, and starting the installed audio/video community application program.

10. An audio/video community virtual room accessing system, comprising:
a trigger module configured to receive a trigger request on a link address corresponding to a visual room identifier displayed on a group webpage, wherein a corresponding relationship exists between the visual room identifier and a group identifier; and
an execution module configured to, according to the trigger request, start an audio/video community application program to enter a virtual room interactive interface of the link address corresponding to the visual room identifier.

11. The audio/video community virtual room accessing system according to claim 10, further including:
an association module configured to obtain an association request and to establish a corresponding relationship between the group identifier and the virtual room identifier according to the association request.

12. The audio/video community virtual room accessing system according to claim 11, wherein the association module further includes:
an operation obtaining unit configured to obtain association operation on a virtual room configuration interface; and
a first relationship establishing unit configured to, according to the association operation, establish a corresponding relationship between one or more selected group identifiers and a virtual room identifier.

13. The audio/video community virtual room accessing system according to claim 12, further including:
a login module configured to log in the audio/video community and to access the virtual room configuration interface; and
a display module configured to obtain group identifiers and to display the group identifiers on the virtual room configuration interface.

14. The audio/video community virtual room accessing system according to claim 11, wherein the association module further includes:
an input unit configured to obtain the virtual room identifier entered in an input box corresponding to a group identifier on an association configuration webpage interface; and
a second relationship establishing unit configured to establish a corresponding relationship between the entered virtual room identifier and the group identifier.

15. The audio/video community virtual room accessing system according to claim 11, further including:
an association cancellation module configured to obtain an association cancel request and to cancel the corresponding relationship between the group identifier and the virtual room identifier according to the association cancel request.

16. The audio/video community virtual room accessing system according to claim 11, further including:
a marking module configured to mark a status flag of the corresponding relationship between the group identifier and the virtual room identifier; and
a recording module configured to record the status flag.

17. The audio/video community virtual room accessing system according to claim 11, further including:
a permission setting module configured to predefine permission levels of group member identifiers; and
a determining module configured to:
after the association module obtains the association request initiated by a group member identifier, determine whether a permission level of the group member identifier is greater than or equal to a predetermined permission threshold; and
when the permission level of the group member identifier is greater than or equal to the predetermined permission threshold, establish the corresponding relationship between the group identifier and the virtual room identifier according to the association request.

18. The audio/video community virtual room accessing system according to claim 10, further including:
a detection module configured to determine whether the audio/video community application program is installed; and
a download module configured to, when the audio/video community application program is not installed, download an installation file of the audio/video community application program, to execute the installation file to install the audio/video community application program, and to start the installed audio/video community application program,
wherein the execution module is further configured to, when the audio/video community application program is installed, start the audio/video community application program according to the trigger request.
